(19) United States
(12) Patent Application Publication
(10) Pub. No.: US 2013/0033013 A1
(43) Pub. Date: Feb. 7, 2013

(54) SELF-LUBRICATING SPHERICAL PLAIN BEARING FOR A VEHICLE SUSPENSION SYSTEM

(71) Applicant: James Voisine, Burlington, CT (US)

(72) Inventor: James Voisine, Burlington, CT (US)

(73) Assignee: ROLLER BEARING COMPANY OF AMERICA, INC., Oxford, CT (US)

(21) Appl. No.: 13/491,659

(22) Filed: Jun. 8, 2012

Related U.S. Application Data
(60) Provisional application No. 61/515,526, filed on Aug. 5, 2011.

(51) Int. Cl. F16C 33/10; B62D 55/06; B60G 7/02

(52) U.S. Cl. 280/28.5; 384/286; 280/124.1

(57) ABSTRACT

A bearing for a vehicle suspension system is provided and includes an outer member and an inner member. The outer member defines a first inner surface and a first outer surface wherein the first outer surface is configured to engage an equalizer bar of the vehicle suspension system. The inner member defines a second outer surface and a bore therethrough defining a second inner surface. The inner member is configured to engage a frame of the vehicle suspension system. A first lubricious fabric liner is provided in communication with at least a portion of the first inner surface and the second outer surface. The first lubricious fabric liner slidingly engages at least a portion of one of the first inner surface and the second outer surface in response to relative movement between the equalizer bar and the frame of the vehicle suspension system.

### CROSS-REFERENCE TO RELATED APPLICATION

This application claims the benefit of U.S. Provisional Patent Application Ser. No. 61/515,526; filed on Aug. 5, 2011, which is incorporated herein by reference in its entirety.

### TECHNICAL FIELD

The present invention is generally related to bearings and is more particularly directed to a bearing operable with a vehicle suspension system. In particular, the present invention is directed to a self-lubricating assembly that is configured to engage the suspension system of a tracked vehicle.

### BACKGROUND OF THE INVENTION

A tracked vehicle generally refers to a self-propelled vehicle that runs on one or more continuous tracks instead of wheels. Some common tracked vehicles include construction vehicles such as bulldozers, military vehicles such as tanks, and even recreational vehicles such as snowmobiles. A tracked vehicle is propelled by one or more endless belts or treads that may be fabricated from metal or a suitable elastomeric material. The use of tracks instead of wheels provides the vehicle with increased contact over a larger surface area than is provided by the use of wheels. As a result, a tracked vehicle exerts a much lower force per unit area on the ground being traversed than a conventional wheeled vehicle of the same weight. This makes them suitable for use on soft, low friction and uneven ground such as mud, ice and snow. However, tracks are more complex than wheels and are susceptible to failure modes such as snapped or derailed tracks.

A tracked vehicle typically includes a main frame that defines a portion of a body of the vehicle, and a pair of undercarriages mounted on the main frame. Each undercarriage typically includes a frame member rotatably coupled to a drive sprocket, an idler wheel, and one or more roller wheels. The tread or belt is looped around the drive sprocket, the idler wheel and the roller wheels. An equalizer bar connects the undercarriages together and is pivotally mounted to the main frame. The equalizer bar typically is connected to the undercarriages.

Spherical plain bearings have traditionally been comprised of a ball positioned for rotational movement in an outer race. The outer race defines an inner surface contoured to receive and retain the ball therein. A lubricant is typically provided between the spherical outer surface of the ball and the inner surface of the outer race to reduce friction therebetween.

### SUMMARY OF THE INVENTION

According to aspects illustrated herein, there is provided a bearing for a vehicle suspension system that includes an outer member and an inner member. The outer member defines a first inner surface and a first outer surface wherein the first outer surface is configured to engage an equalizer bar of the vehicle suspension system. The inner member defines a second outer surface and a bore therethrough defining a second inner surface. The inner member is configured to engage a frame of the vehicle suspension system. A first lubricious fabric liner is provided in communication with at least a portion of the first inner surface and the second outer surface. The first lubricious fabric liner slidingly engages at least a portion of one of the first inner surface and the second outer surface in response to relative movement between the equalizer bar and the frame of the vehicle suspension system.

According to other aspects illustrated herein, there is provided a vehicle suspension system that includes a frame, an equalizer bar in communication with the frame, and at least one bearing in communication with the frame and the equalizer bar. The bearing has an outer member that defines a first inner surface and a first outer surface. The bearing also has an inner member that defines a second outer surface and a bore therethrough defining a second inner surface. A first lubricious fabric liner positioned on at least a portion of the first inner surface and a second lubricious fabric liner positioned on the second inner surface. A shaft extends into the bore and is in communication with the frame and the equalizer bar.

According to still other aspects illustrated herein, there is provided a suspension system of a tracked vehicle. The suspension system includes a first and a second undercarriage pivotally connectable to a main frame of the tracked vehicle an equalizer bar pivotally connectable to the main frame and the first and second undercarriages. A first spherical plain bearing has an outer race and an inner ring and is in communication with the first undercarriage and the equalizer bar. Similarly, a second spherical plain bearing has an outer race and an inner ring and is in communication with the second undercarriage and the equalizer bar. A first lubricious fabric liner is positioned on at least a portion of an inner engagement surface of the outer race of each of the first and second spherical plain bearings. A second lubricious fabric liner is positioned on at least a portion of an inner surface of a bore defined through the inner ring of each of the first and second spherical plain bearings. A first shaft extends through the inner ring of the first spherical plain bearing and is in communication with the first undercarriage and the equalizer bar. Similarly, a second shaft extends through the inner ring of the second spherical plain bearing and is in communication with the second undercarriage and the equalizer bar.

### BRIEF DESCRIPTION OF THE DRAWINGS

FIG. 1 is a side view of a tracked vehicle having a suspension system incorporating a self-lubricating bearing in accordance with the present invention.

FIG. 2 is a partial perspective, schematic, view of the suspension system of the tracked vehicle of FIG. 1

FIG. 3 is a partial exploded perspective view of a frame coupling member incorporating a bearing of the present invention.

FIG. 4 is a cross-sectional view of a spherical plain bearing in accordance with the present invention.

FIG. 5 is a cross-sectional view of a portion of the spherical plain bearing assembly of FIG. 4.

FIG. 6 is a cross-sectional view of another portion of the spherical plain bearing assembly of FIG. 4.

FIG. 7 is an enlarged cross sectional schematic illustration of a woven low friction liner.

### DETAILED DESCRIPTION

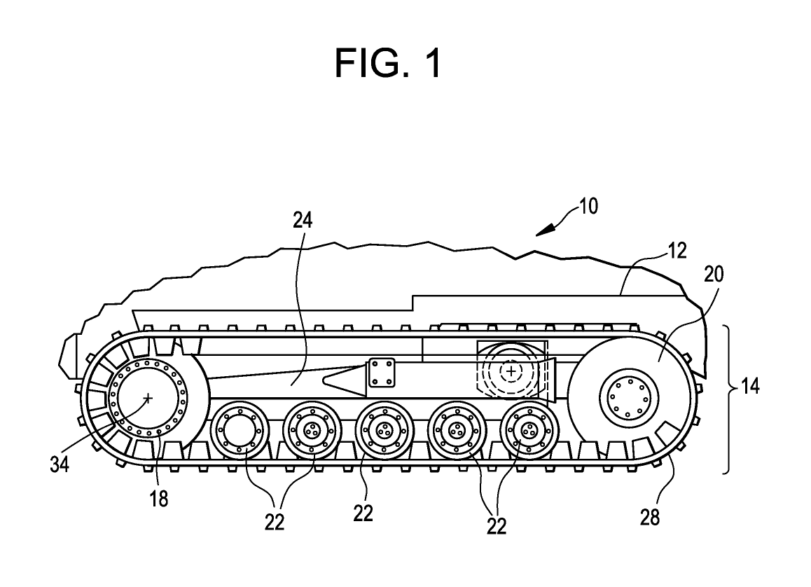

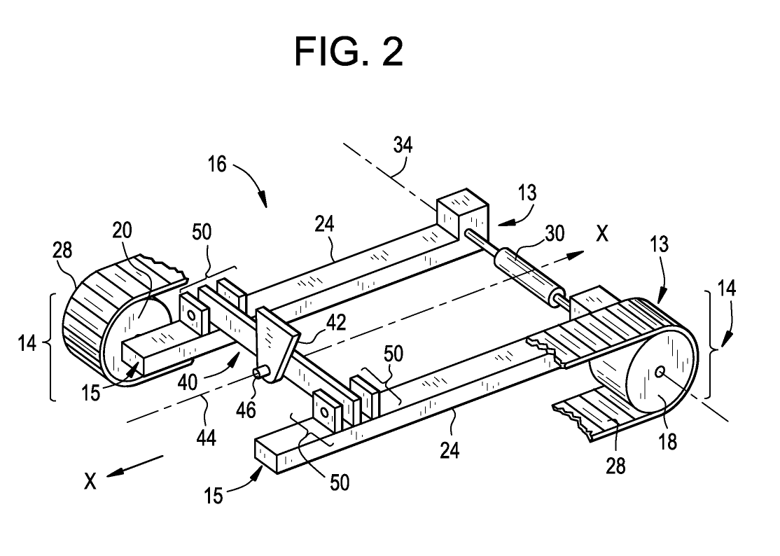

As shown in FIGS. 1 and 2, a portion of a tracked vehicle is generally designated by the reference number 10 and is hereinafter referred to as the “vehicle 10.” The tracked vehicle 10 may be a bulldozer, tank or other military vehicle, or the like. The vehicle 10 includes a longitudinally extending main frame 12 having two undercarriages 14 positioned below the main frame 12 and forming a part of a suspension system 16 of the vehicle 10. Each of the undercarriages 14 extends in a longitudinal direction designated by the arrow labeled “X-X” along laterally opposing sides of the main frame 12.

Each of the undercarriages 14 includes a frame member 24 mounted therein. A drive sprocket 18 is rotatably coupled to the frame member 24. Similarly, an idler wheel 20 is rotatably mounted to the frame member 24 at an end thereof generally opposite the drive sprocket 18. A plurality of roller wheels 22 (five shown) are rotatably mounted to the frame member 24 and are positioned between the drive sprocket 18 and the idler wheel 20. While five roller wheels 22 have been shown and described, the present invention is not limited in this regard as more than five or less than five roller wheels can be employed without departing from the broader aspects of the present invention. A belt 28 of linked tracks forms an endless loop around the drive sprocket 18, the idler wheel 20, the roller wheels 22, and the frame member 24 of each undercarriage 14. While a belt of linked tracks has been shown and described, the present invention is not limited in this regard as other configurations forming an endless belt around a drive sprocket, such as, for example, an elastomeric belt, a tread and the like, may be used without departing from the broader aspects of the invention.

Each drive sprocket 18 is coupled to a drive axle 30 such that a rear end 13 of each frame member 24 is connected to the drive axle, concentric about an axis 34. The present invention is not limited to the connection of the drive sprockets 18 to the drive axle 30; for example, the drive sprockets may be independently coupled to and driven by suitable drive motors. Forward ends 15 of both frame members 24 are interconnected via an equalizer bar 40 extending transversely below the main frame 12. The equalizer bar 40 is connected to the main frame 12 via a coupling member 42 extending from the main frame 12 (not shown in FIG. 2). While the equalizer bar 40 has been shown and described, the present invention is not limited in this regard as other sufficiently rigid members may be used for connecting the undercarriages to the main frame, such as, for example, a stabilizer bar, without departing from the broader aspects of the invention.

In the illustrated embodiment, the coupling member 42 is pivotally connected to the equalizer bar 40 approximately at a midpoint thereof using a pivot pin 46. The equalizer bar 40 can pivot about an axis 44. Although the coupling member 42 is shown as being a plate connected to the equalizer bar 40 using the pivot pin 46, the present invention is not limited in this regard, and other configurations are possible including but not limited to a bearing or any one of a number of pivotably connectable fasteners. The ends of the equalizer bar 40 are each connected to the frame members 24 using respective coupling members 50.

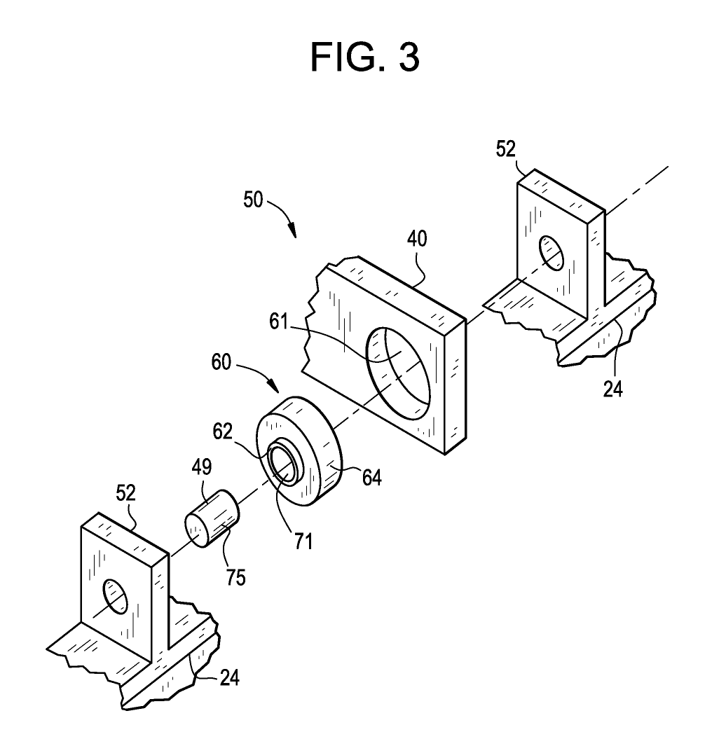

As shown in FIG. 3, each of the coupling members 50 is defined by two brackets 52 that are secured to or integrally formed with the frame member 24. A spherical plain bearing, designated by the reference number 60 and hereinafter referred to as “bearing 60”, is positioned in a bore 61 defined by the equalizer bar 40. A shaft 49 extends through the bearing 60. The ends of the shaft 49 are secured to the brackets 52 using pins or any other suitable means. The present invention is not limited to the use of brackets 52; for example, any configuration suitable for connecting the equalizer bar 40 to the frame member 24 and employing the bearing 60 may be employed including but not limited to a bearing or any one of a number of pivotably connectable fasteners. While a spherical plain bearing is shown and described, the present invention is not limited in this regard as the features and elements described herein with respect to the spherical plain bearing apply to other bearing assemblies, such as, for example, ball bearings, journal bearings, needle bearings, thrust bearings and the like, without departing from the broader aspects of the invention.

As further shown in FIG. 3, the frame members 24 are spaced apart from one another such that one coupling member 50 is in pivotable engagement with one frame member 24 and the equalizer bar 40 proximate to one end of the equalizer bar 40 via a bearing 60. Similarly, another coupling member 50 is in pivotable engagement with another frame member 24 and the equalizer bar 40 proximate to the other end of the equalizer bar 40 via another bearing 60. Accordingly, the frame members 24 may move relative to one another via the coupling members 50; and each frame member 24 may move relative to main frame 12 via the coupling member 42.

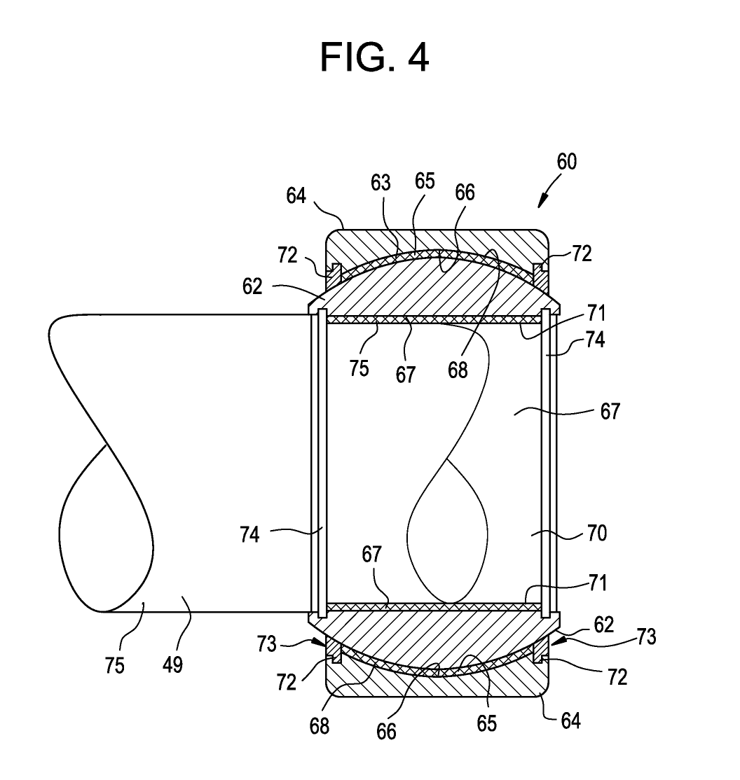

As shown in FIG. 4, one embodiment of the bearing 60 includes an inner member such as an inner ring 62 positioned in an outer member such as an outer race 64. The outer member may be formed integral with the equalizer bar. The inner ring 62 defines an outer spherical surface 63. As shown in the illustrated embodiment, the outer race 64 defines an inner engagement surface 66 complementarily shaped to slidingly engage outer spherical surface 63 of inner ring 62. The outer race 64 may be carburized or have a reduced hardness, as compared to the inner ring 62, to improve resistance to forces that may cause fracturing. During use of the bearing 60, one or both of the outer spherical surface 63 and the inner engagement surface 66 are movable relative to each other. In the illustrated embodiment, the inner ring 62 defines a bore 70 extending therethrough, the bore being adapted to receive a portion of the shaft 49, which is connected to the frame member 24 via the bracket 52. While the bore 70 has been shown and described as extending through the inner ring 62, the present invention is not limited in this regard as the bore can also extend only partway through the inner ring. The shaft 49 can also be part of the inner ring 62.

The outer race 64 includes grooves 73 in which seals 72 are positioned. The seals 72 extend circumferentially around the inner engagement surface 66. As is shown, the seals 72 are positioned proximate the edges of the inner engagement surface 66 to prevent or inhibit the ingress of dirt or other debris into the bearing 60 between the outer spherical surface 63 and the inner engagement surface 66. The inner ring 62 also includes grooves in which seals 74 are positioned. The seals 74 are located in the surface defining the bore 70, each seal 74 being positioned proximate a respective edge of the inner ring through which the bore extends.

The inner ring 62 can be fabricated from any suitable material including but not limited to steel, steel alloys, nickel alloys, aluminum, aluminum alloys, silicon nitride, silicon carbide, zirconium, and the like. The outer race 64 can be fabricated from any suitable material including but not limited to steel, steel alloys, aluminum, aluminum alloys, magnesium, magnesium alloys, and the like.

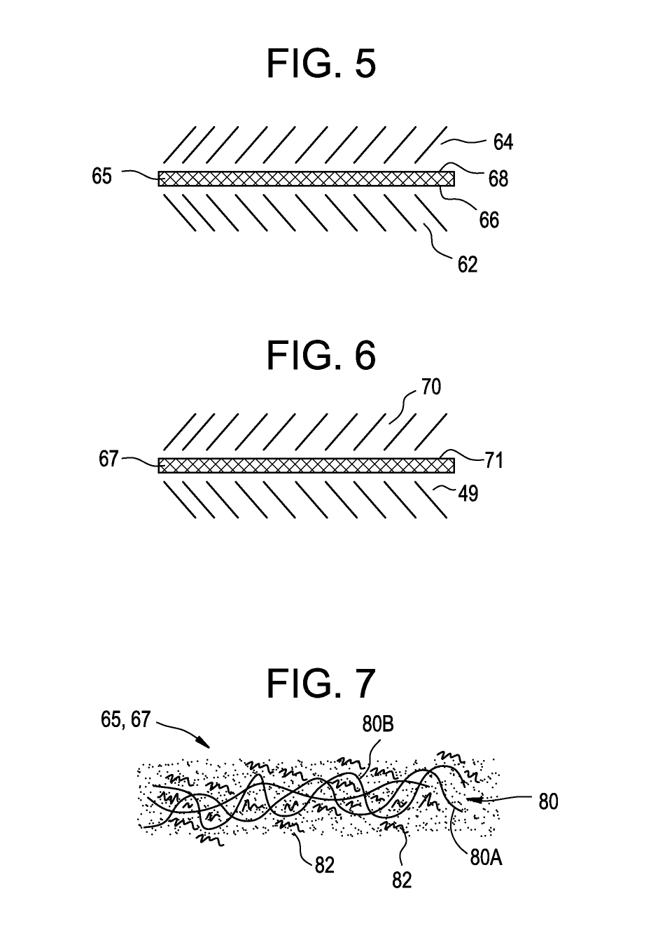

As further shown in FIG. 5, the outer race 64 includes a first self-lubricating liner such as a first lubricious fabric liner 65 bonded to a portion of the inner engagement surface 66. The present invention is not limited to the first lubricious fabric liner 65 being bonded to a portion of the inner engagement surface 66, as the first lubricious fabric liner 65 may be bonded to the entire inner engagement surface 66 or to all or a portion of an outer engagement surface 68 of the inner ring 62. Also, the first lubricious fabric liner 65 may simply be positioned between the inner engagement surface 66 and the outer engagement surface 68 rather than being bonded to either engagement surface.

As further shown in FIG. 6, the inner ring 62 also includes a second self-lubricating liner such as a second lubricous fabric liner 67 that is bonded to a portion of an inner engagement surface 71 defining the bore 70 of the inner ring 62. Again, the present invention is not limited to the second lubricious fabric liner 67 being bonded to a portion of the inner engagement surface 71, as the second lubricious fabric liner 67 may be bonded to the entire inner engagement surface 71 or to all or a portion of an outer engagement surface 75 of the shaft 49 (shown in FIG. 3). Also, the second lubricious fabric liner 67 may simply be positioned between the inner engagement surface 71 and the outer engagement surface 75 rather than being bonded to either engagement surface.

The slideable engagement of the first lubricious fabric liner 65 on the inner engagement surface 66 with the outer engagement surface 68, and the slideable engagement of the second lubricious fabric liner 67 on the inner engagement surface 71 with the shaft 49, results in providing a constant lubrication within the two wear paths. Use of such fabric liners obviates the need for added lubrication, for example oil or grease. However, the present invention is not limited in this regard as an added lubricant such as oil or grease may be used in the bearing 60.

The first and second lubricous fabric liners 65 and 67 are manufactured from a material having low friction characteristics or qualities. In one embodiment, as shown for example in FIG. 7, the first and second lubricous fabric liners 65 and 67 comprise a woven fabric generally designated by the reference number 80. The woven fabric 80 includes a plurality of fibers 80A and 80B interwoven with one another and polytetrafluoroethylene (PTFE) 82 interwoven therewith. The fibers 80A and 80B include, for example, a polyester material, a stainless steel material and/or glass material. The fibers 80A and 80B interwoven with the PTFE enhance bondability of the first and second lubricous fabric liners 65 and 67. In one example, the first and second lubricous fabric liners 65 and 67 are manufactured from Fabroid®, in particular Fabroid G, which is commercially available from RBC Bearings, Oxford, Connecticut, United States. In another embodiment, the first and second lubricous fabric liners 65 and 67 are manufactured from Fiberglide, which is also commercially available from RBC Bearings. In addition, other materials (e.g., boron nitride, calcium fluoride, cerium fluoride, tungsten disulfide, copper, brass, and the like) may be used to form the first and second lubricous fabric liners 65 and 67 and are considered within the scope of the invention. The first and second lubricous fabric liners 65 and 67 have properties and characteristics sufficient to withstand high loads with insignificant wear. Thus, bearing 60 and the first and second lubricous fabric liners 65 and 67 are operational for extended life when compared to prior art bearings.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A bearing for a vehicle suspension system, the bearing comprising:
an outer member defining a first inner surface and a first outer surface, the first outer surface being configured to engage an equalizer bar of the vehicle suspension system;
an inner member defining a second outer surface and a bore therethrough defined by a second inner surface, the inner member being configured to engage a frame of the vehicle suspension system; and
a first lubricious fabric liner in communication with at least a portion of the first inner surface and the second outer surface wherein the first lubricious fabric liner slidingly engages at least a portion of one of the first inner surface and the second outer surface in response to relative movement between the equalizer bar and the frame of the vehicle suspension system.

2. The bearing of claim 1 further comprising a second lubricious fabric liner in communication with at least a portion of the second inner surface and a shaft extending into the bore wherein the shaft is operable to connect the inner member to the frame of the vehicle suspension system.

3. The bearing of claim 1 wherein the outer member is an outer race and the inner member is an inner ring.

4. A vehicle suspension system comprising:
a frame;
an equalizer bar in communication with the frame;
at least one bearing in communication with the frame and the equalizer bar, the bearing having an outer member defining a first inner surface and a first outer surface, and the bearing having an inner member defining a second outer surface and a bore therethrough defined by a second inner surface;
a first lubricious fabric liner positioned on at least a portion of the first inner surface;
a second lubricious fabric liner positioned on at least a portion of the second inner surface; and
a shaft extending into the bore and in communication with the frame and the equalizer bar.

5. The vehicle suspension system of claim 4 further comprising:
at least two frames;
a first bearing in communication with one frame and the equalizer bar, the bearing positioned proximate to one end of the equalizer bar;
a second bearing in communication with another frame and the equalizer bar, the bearing positioned proximate to the other end of the equalizer bar;
a first lubricious liner positioned on at least a portion of the first inner surface of each bearing;
a second lubricious liner positioned on at least a portion of the second inner surface of each bearing; and
a shaft extending into the bore of each inner member of each bearing and each shaft is in communication with at least one frame and the equalizer bar.

6. The vehicle suspension system of claim 4 wherein the at least one bearing comprises a spherical plain bearing.

7. The vehicle suspension system of claim 4 wherein the outer member is an outer race and the inner member is an inner ring.

8. A suspension system of a tracked vehicle, the suspension system comprising:
a first undercarriage pivotally connectable to a main frame of the tracked vehicle;
a second undercarriage pivotally connectable to the main frame;
an equalizer bar pivotally connectable to the main frame and the first and second undercarriages;
a first spherical plain bearing having an outer race and an inner ring and being in communication with the first undercarriage and the equalizer bar; and
a second spherical plain bearing having an outer race and an inner ring and being in communication with the second undercarriage and the equalizer bar;
a first lubricious fabric liner positioned on at least a portion of an inner engagement surface of the outer race of each of the first and second spherical plain bearings;
a second lubricious fabric liner positioned on at least a portion of an inner surface of a bore defined through the inner ring of each of the first and second spherical plain bearings;
a first shaft extending through the inner ring of the first spherical plain bearing in communication with the first undercarriage and the equalizer bar; and
a second shaft extending through the inner ring of the second spherical plain bearing in communication with the second undercarriage and the equalizer bar.
